(19) United States
(12) Patent Application Publication
(10) Pub. No.: US 2020/0081543 A1
(43) Pub. Date: Mar. 12, 2020

(54) METHOD AND DEVICE FOR GENERATING TACTILE PATTERNS

(71) Applicants: Centre National De La Recherche Scientifique, Paris (FR); Ecole Centrale De Lille, Villeneuve D'Ascq (FR); Universite De Lille, Lille (FR)

(72) Inventors: Eric Vezzoli, Grenoble (FR); Laurent Grisoni, Tourcoing (FR); Betty Lemaire-Semail, Lille (FR); Frederic Giraud, Marcqen-Baroeul (FR)

(21) Appl. No.: 16/610,114

(22) PCT Filed: Apr. 30, 2018
(86) PCT No.: PCT/EP2018/061010

§ 371 Date: Nov. 1, 2019

(30) Foreign Application Priority Data
May 2, 2017 (FR) 1753830

(51) Int. Cl. G06F 3/01; G06F 3/0354; G06F 3/041

(52) U.S. Cl. CPC G06F 3/016; G06F 2203/014; G06F 3/0412; G06F 3/03547

(57) ABSTRACT

A method for generating at least one tactile pattern using a haptic feedback device (70) having an active space within which a user can move his finger (F) in order to feel the tactile pattern, the perception of the pattern being caused by the modulation of the mechanical excitation of the finger pad by an excitation element, the method having the steps involving:
detecting (100) the position of the finger (F) in the active space;
calculating (101) the speed of the finger,
determining (102), for each detected position of the finger, an associated taxtel within a predefined grid of taxtels, each taxtel having an associated texture value that is dependent on the tactile pattern to be reproduced, each taxtel having its largest dimension less than or equal to 8 mm,
generating (103, 104, 105), on the basis of the texture value associated with this taxtel, a control signal for controlling the excitation element, this excitation signal being dependent on the speed of the finger at least for the densest tactile patterns to be reproduced.

The present invention concerns a method and a device for generating tactile patterns, in particular for password authentication of a user.

The use of 2D touch systems is everywhere in today's world, where the principle means of interaction is the pressure of a finger on the screen of a device, for example a smartphone or a tablet.

The capability of 2D interfaces of rendering different haptic sensations is quite limited at present, and is based primarily on vibration of the whole of the device, which limits the haptic rendering capabilities of said interfaces.

The application EP 1 956 466 presents a vibrating haptic interface having a contact surface and transducers vibrating the contact surface by using standing waves.

The application FR 2 975 197 discloses a vibrating haptic interface and a display screen implementing such an interface.

The application US 2012/0223880 proposes a system for generating dynamic haptic effects in response to input signals, which can be signals from (position, pressure, proximity, etc.) sensors or haptic signals sent by the touch surface to the processor responsible for generating the haptic effects. These effects can be displayed to the user on haptic devices in a vibrotactile form. The size of the display grid is modified on the basis of the velocity of the finger.

The application US 2016/0328019, for its part, describes an electronic device having a touch surface divided into subsurfaces where vibrations are generated from vibration elements. This generation is effected on the basis of the position and the speed of the finger.

The application US 2015/0138109 discloses a touchscreen having a touchpad detecting the position of the finger of the user, a speed calculation unit that determines the speed of movement of the finger at each detected position, a region configuration unit that compares the speed with a threshold value in order to place a reaction region on the screen in relation to the detected position and a vibration control unit that assesses whether the finger is positioned inside the reaction region.

Similarly, the development of 3D virtual reality devices is well known. A helmet is used that immerses the user in a virtual world.

In the case of 3D devices, it is possible to associate with the virtual reality helmet devices capable of detecting the position of the hand in space, and of producing haptic information, for example in the form of a localized pressure, on the finger pad of the user. These haptic devices can take the form of an exoskeleton, a virtual reality glove or the like.

In the field of haptics, few technologies are compatible with the capacitive position sensing techniques used in many 2D touchscreens; among them are friction modulation techniques, namely electrical adhesion and ultrasonic vibrations.

Electrical adhesion increases the friction between the finger and a surface through local electrostatic attraction created by applying a higher voltage to this surface.

Ultrasonic vibrations allow local reduction of friction on the basis of the vibratory state of the explored surface.

A conventional strategy for reproducing textures on a flat surface through friction modulation is based on comparison of a detected position of the finger with a preexisting map defining the tactile patterns to be reproduced on the basis of the position, such a map being described as a “friction map”.

It is possible to introduce the concept of “position-based control” in order to describe this strategy, which determines the value of amplitude of vibrations as a function of the absolute position of the finger within a given friction map.

The position-based control technique is reliant, in order to reproduce textures, on the accuracy and the passband of the system for sensing the position of the finger.

Various solutions have been proposed to improve the passband, such as optical solutions as proposed in the chapter of the book edited by the Springer company entitled “A high-fidelity surface-haptic device for texture rendering on bare finger” by M. Wiertlewski et al.

Other solutions have been proposed, based on the detection of a force, as described in the article “A tactile input device with programmable friction” by M. Amberg et. al, ACM 2011.

Thus, a system for sensing the position of the finger that is noisy or has a small passband does not allow generation of a tactile pattern having a resolution as high as is desirable. By way of example, a capacitive touchscreen having an acquisition frequency of 50 Hz is only capable of reproducing a tactile grid with a period of 1 mm, for a 25 mm/s speed of movement of the finger over the screen.

The approach called “texture-based control” consists in defining a haptic pattern that is dependent on the velocity of the finger, said velocity being updated in each acquisition cycle, e.g. at a refresh rate of 50 Hz for a capacitive touchscreen.

By implementing the texture-based control technique, it is possible to reproduce the entire passband of a periodic haptic signal using a capacitive position sensor, owing to the limited derivative of the velocity function for a sampled position. However, the disadvantage of this technique is the error in the spatial phase of the signal, this error being all the larger the larger the spatial period.

The two “position-based control” and “texture-based control” approaches presented above are described in the article entitled “Texture rendering strategies with a high fidelity capacitive visual-haptic friction control device” published by the Springer publishing company in 2016.

There is thus a need to further improve haptic interfaces and in particular to increase the rendering capabilities of these interfaces.

The invention aims to meet this need and does so by virtue of a method for generating at least one tactile pattern using a haptic feedback device having an active space within which a user can move his finger in order to feel the tactile pattern, the perception of the pattern being caused by the modulation of the mechanical excitation of the finger pad by an excitation element, the method having the steps involving:
detecting the position of the finger in the active space;
calculating the speed of the finger,
determining, for each detected position of the finger, an associated taxtel within a predefined grid of taxtels, each taxtel having an associated texture value that is dependent on the tactile pattern to be reproduced, each taxtel having its largest dimension less than or equal to 8 mm,
generating, on the basis of the texture value associated with this taxtel, a control signal for controlling the excitation element, this excitation signal being dependent on the speed of the finger at least for the densest tactile patterns to be reproduced.

It is thus advantageously possible to control the excitation on the basis of the tactile pattern to be reproduced, with control of the excitation according to the position of the finger for a low density of the tactile pattern to be reproduced and control of the excitation taking into account the speed of the finger for a high density of the tactile pattern to be reproduced.

Preferably, the tactile pattern generated is periodic in the direction of movement of the finger.

The density of a tactile pattern is defined as being the spatial frequency of the pattern in the direction of movement of the finger. Thus, the high-density pattern has a higher spatial frequency than the low-density pattern.

A spatial frequency density less than or equal to 0.125 mm⁻¹ can correspond to a low-density pattern. A high-density pattern can correspond to a pattern having a spatial frequency higher than 0.125 mm⁻¹.

By virtue of the invention, the two position-based and texture-based control techniques are combined into a single hybrid technique, compensating for the disadvantages of the two techniques and combining the advantages thereof

Textures can be recognized by the user at a lower error rate than that obtained using exclusively one of the two techniques, for different velocities of the finger.

Preferably, the modulation of the mechanical excitation of the finger pad is effected by the modulation of the friction of the finger on a haptic feedback surface via the modulation of a vibratory and/or electrical excitation of the surface.

Preferably, the excitation of the surface is vibratory and the modulation of the friction is performed through the modulation of an ultrasonic vibration. In this case, the modulation of the friction is performed by reducing the apparent coefficient of friction by vibrating the haptic feedback surface.

The excitation of the surface can also be electrical, and the modulation of the friction is performed, in the case of electrical adhesion, by increasing the apparent coefficient of friction by pulling the finger over the haptic feedback surface through the creation of electrostatic forces by applying a high voltage to the surface.

The haptic feedback surface can at least partially overlap a screen. The latter can advantageously be used to present a graphical representation of a generated tactile pattern and to display information in connection with the generated tactile pattern(s). This information can be alphanumeric characters and/or colors and/or logos and/or lines, in particular in the form of a weave. As a variant, the touch surface does not overlap any screen.

The displayed information could be a weave in which the lines are representative of the density of the corresponding tactile pattern. Fine lines close together are representative of a high-density tactile pattern, while broad lines spaced apart are representative of a lower-density tactile pattern.

The display on the screen can be implemented together with the generation of a tactile pattern, in various applications, and in particular in applications in which it is desirable to be able to enter information discreetly, for example for identification purposes.

Preferably, the haptic feedback surface has a plurality of distinct regions in each of which a tactile pattern is capable of being generated. Thus, it is possible to generate haptic codes made up of multiple distinct patterns that the user can perceive during one and the same sweep of the haptic feedback surface. For example, two tactile patterns of different density are generated on the touch surface, said tactile patterns being felt by the user in succession when he sweeps his finger over the touch surface in one and the same direction. Each pattern can be generated in a respective region, depending on the region in which the finger is situated.

In one implementation example of the method, it is determined whether a taxtel corresponding to a recently detected position of the finger encodes a texture identical to that of the taxtel associated with the previously detected position of the finger, and if not a refresh of the control signal is performed.

The control signal can be such that the amplitude of the stimulation A(t) of the finger pad is in the form:

$$A ( t ) = {B}_{1} ( \frac{1}{2} + \frac{1}{2} sin ( 2 Π \frac{\int vdt}{{PS}_{1}} + {Φ}_{1} ) ) + {C}_{1} \qquad ( 1 )$$

where B₁ and C₁ are constants allowing control of the amplitude of the variations of the stimulation and the average level thereof, t is the time, v is the estimated speed of the finger, Φ¹ is the phase of the texture, and PS₁<8 mm is the spatial period of the texture.

During said refresh of the control signal, relationship (1) can be refreshed to become:

$$A ( t ) = {B}_{2} ( \frac{1}{2} + \frac{1}{2} sin ( 2 Π \frac{\int vdt}{{PS}_{2}} + {Φ}_{2} ) ) + {C}_{2} \qquad ( 2 )$$

where B₂ and C₂ are constants allowing control of the amplitude of the variations of the stimulation and the average level thereof.

The phase value Φ₂ can be initialized to a value such that the magnitude A(t) is continuous on changing over from the previous taxtel to the new, or is chosen to be zero.

The invention also relates, according to another of the aspects thereof, to a device for generating at least one tactile pattern, in particular for implementing a method according to the invention as defined above, having:
a haptic feedback device having an active space within which a user can move his finger in order to feel the tactile pattern, the perception of the pattern being caused by the modulation of the mechanical excitation of the finger pad, and
means for controlling the excitation of the surface.

The device for generating at least one tactile pattern, in particular for implementing a method as defined above, can in particular have:
a haptic feedback device having an active space within which a user can move his finger in order to feel the tactile pattern, the perception of the pattern being caused by the modulation of the mechanical excitation of the finger pad by an excitation element, and means for:
detecting the position of the finger in the active space;
calculating the speed of the finger,
determining, for each detected position of the finger, an associated taxtel within a predefined grid of taxtels, each taxtel having an associated texture value that is dependent on the tactile pattern to be reproduced, each taxtel having a largest dimension less than or equal to 8 mm,
generating, on the basis of the texture value associated with this taxtel, a control signal for controlling the excitation element, this excitation signal being dependent on the speed of the finger at least for the densest tactile patterns to be reproduced.

The features described above in connection with the method also hold for such a device.

The invention also relates, according to another of the aspects thereof, to an interface comprising:
a haptic feedback surface over which a user can move his finger in order to perceive at least one tactile pattern, the perception of the pattern being caused by the modulation of the friction of the finger on the surface via the modulation of a vibratory and/or electrical excitation of the surface;
a touchscreen presenting at least one graphical representation of a tactile pattern capable of being generated,
at least one selection means allowing a user of the interface to select a graphical representation of what is perceived.

Such an interface is quite particularly suitable for the input of information in a discrete manner by the user, since an observer of the interface cannot know what is felt by the user moving his finger over said interface.

Preferably, the touchscreen presents multiple graphical representations of tactile patterns capable of being generated. Thus, an observer of the interface cannot know which graphical representation a generated tactile pattern corresponds to.

The haptic feedback surface and the touchscreen can be separate, which can make it easier to construct the interface.

The selection means is preferably displayed on the screen, for example in the form of a confirmation key and/or at least one navigation key.

According to one advantageous feature, the haptic feedback surface has a plurality of distinct regions in each of which a tactile pattern is capable of being generated. By way of example, the haptic feedback surface has two adjacent regions in which two different tactile patterns can be generated. This allows the user to perceive different codes formed from generated tactile patterns by sweeping his finger over said regions.

Preferably, a graphical representation has as many distinct regions as the haptic feedback surface, each of these regions expressing in particular the presence or the absence of a generated tactile pattern and the nature, for example dense or sparse, of the pattern that is generated. For example, each graphical representation has two regions in which two distinct patterns are displayed, corresponding to two respective tactile patterns. This allows the number of combinations between tactile patterns to be increased and therefore facilitates the input of information using the interface.

The presence of a tactile pattern is advantageously represented by a set of lines of greater or lesser width and with greater or lesser spacing from one another. In particular, two different graphical representations can have weave spatial frequencies that differ in the same way as the corresponding tactile patterns; in other words, a sparse tactile pattern will be able to correspond to a weave having broad lines spaced apart, or a low spatial frequency, while a denser tactile pattern will be able to be represented by a weave having fine lines closer together, therefore a higher spatial frequency. The lines are preferably arranged transversely, or rather perpendicularly, to the direction of movement of the finger.

The interface can be configured to allow its user, following recognition of the perceived tactile pattern, to use said at least one selection means to select a graphical representation displayed on the screen of the interface.

In one implementation example, multiple information encoding elements are displayed on the screen, for example in the form of characters, in particular numbers, and a graphical representation of a corresponding tactile pattern, in particular having two distinct regions able to express combinations of different or identical weaves or the absence of a tactile pattern, is associated with each information encoding element. Thus, it is possible to display multiple encoding elements and, for each one, a graphical representation of tactile patterns of its own. For example, one encoding element is associated with two fine dense weaves, and another encoding element with a fine-lined weave and with a broad-lined weave. A tactile pattern corresponding to one of the information encoding elements is generated at random. The user can explore the touch surface by touch in order to recognize the pattern and find out which encoding element it corresponds to. The interface allows navigation between the information encoding elements up to the one that needs to be selected. During this navigation, the tactile pattern corresponding to the information encoding element being selected is generated on the touch surface, whereas the display on the screen does not change. The user can thus successively scroll through the tactile patterns on the touch surface while mentally moving from one encoding element to another on the screen until the next encoding element to be selected is reached. He can then operate the selection means.

The invention also relates, according to another of the aspects thereof, to a method allowing a user to enter information, by implementing the interface according to the invention above, comprising:

a) generation, on the haptic feedback surface, of at least one tactile pattern to be perceived by a user of the interface; and

b) detection of a selection, by the user, of a graphical representation displayed on the screen of the interface.

Preferably, step a) is effected using the method for generating tactile patterns according to the invention, as defined earlier on.

This method advantageously comprises comparison between the selection made and expected data.

This method preferably comprises generation of authentication information for the user on the basis of the result of the comparison.

Preferably, this method implements the interface described above having at least one navigation key and/or a confirmation key for selection means.

The user can press the navigation key in order to change over from the perception of one tactile pattern to another. The user can then confirm the selection by pressing the confirmation key.

Moreover, when the friction of the finger is modulated via a modulation of a vibratory, in particular ultrasonic, excitation, the known vibrating slabs used to produce the haptic feedback surfaces are produced using a plate that has piezoelectric transducers fixed to one face thereof.

Said piezoelectric transducers have a piezoelectric material arranged between conductive layers used as electrodes. Accessing the layer situated on the side of the plate is hampered by its fixing to the latter, which makes connection more complex.

There is therefore a need to make it easier to manufacture such slabs, and the invention achieves this aim, according to another of the aspects thereof, by virtue of a haptic feedback slab having:
a plate defining a contact surface; and
at least one piezoelectric transducer having a piezoelectric material arranged between two conductive electrical layers, one of which is fixed to the plate,

said slab being characterized by the fact that the conductive electrical layer opposite the one fixed to the plate is interrupted in order to form two power supply electrodes of the transducer.

It is thus no longer necessary to supply power to the conductive electrical layer used for fixing to the plate, and manufacture of the slab is simplified thereby.

According to one advantageous feature of the invention, the interrupted layer is interrupted in an area corresponding to a vibration node.

The length of a power supply electrode is preferably close to a half-wavelength of the generated vibration, preferably being between 0.9 and 1 times the half-wavelength.

Preferably, the aforementioned plate is made of a material selected from among:
glass or another transparent material;
an opaque material, in particular a metal, for example copper or aluminum.

This haptic feedback slab is quite particularly suitable for producing the interface as defined earlier on.

The invention will be able to better understood on reading the detailed description of nonlimiting implementation examples of said invention that follows and on considering the appended drawing, in which:

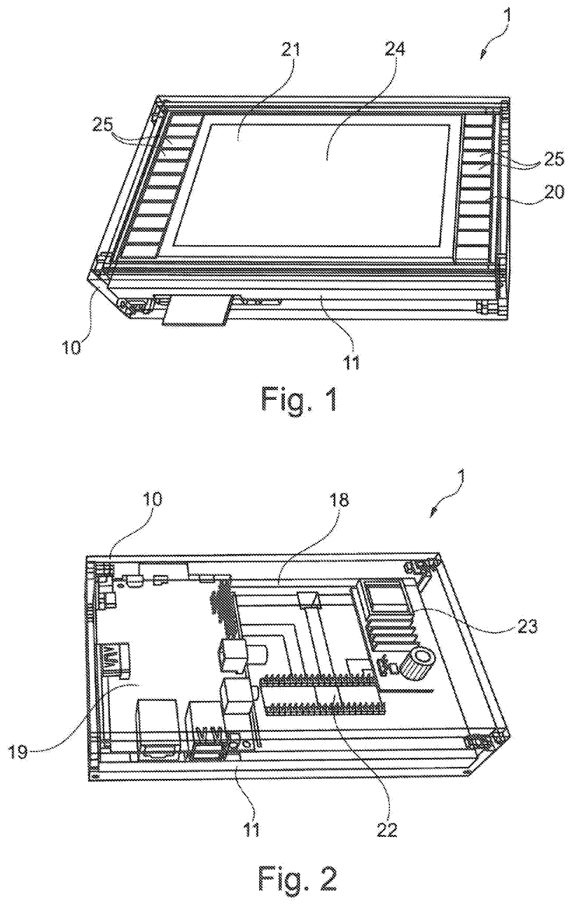

FIGS. 1 and 2 schematically and partially depict an example of a device for generating vibrations with and without the haptic feedback slab, respectively;

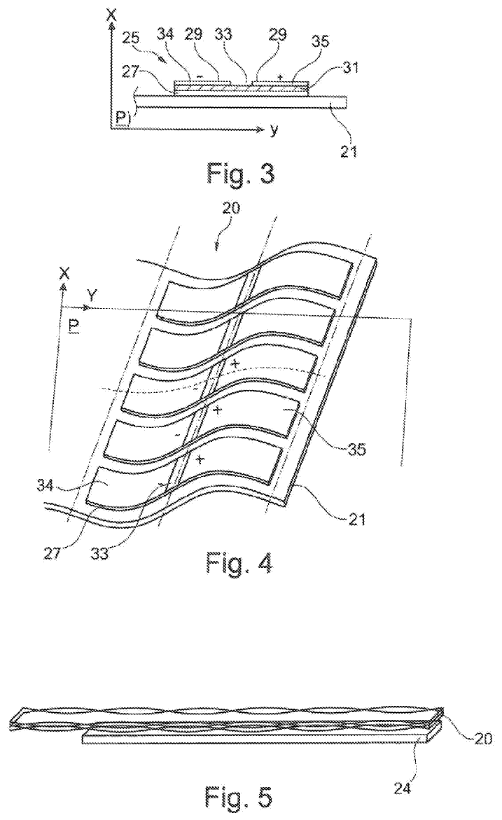

FIG. 3 is a schematic and partial cross section of the excitation part of the haptic feedback slab;

FIGS. 4 and 5 illustrate the fact of the haptic feedback slab being vibrated;

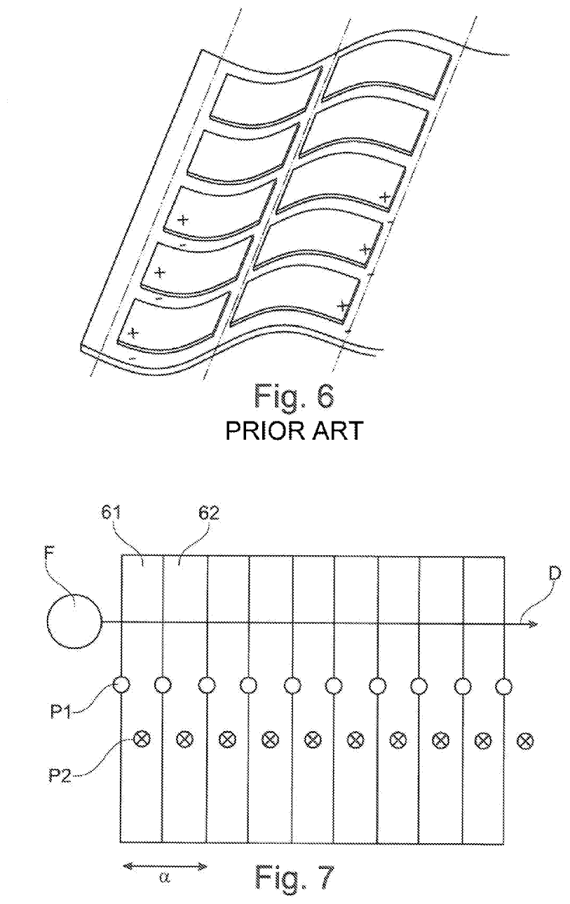

FIG. 6 is a view analogous to FIG. 4 of a haptic feedback slab according to the prior art;

FIG. 7 schematically illustrates an example of position-based control and texture-based control;

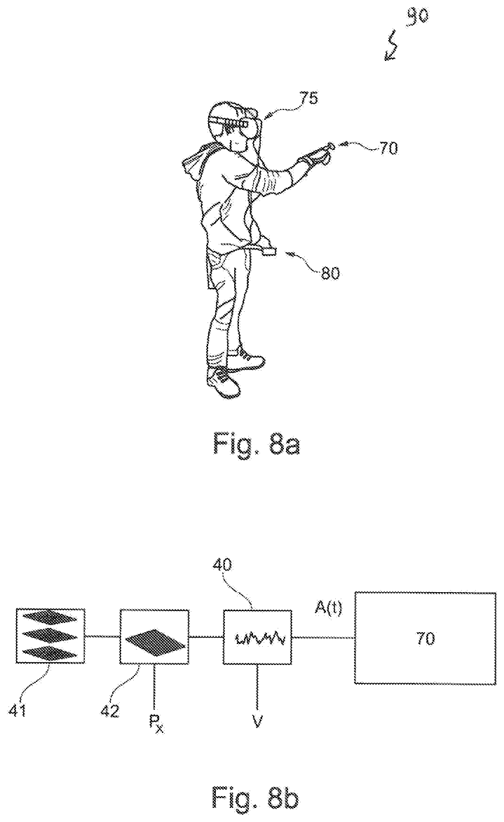

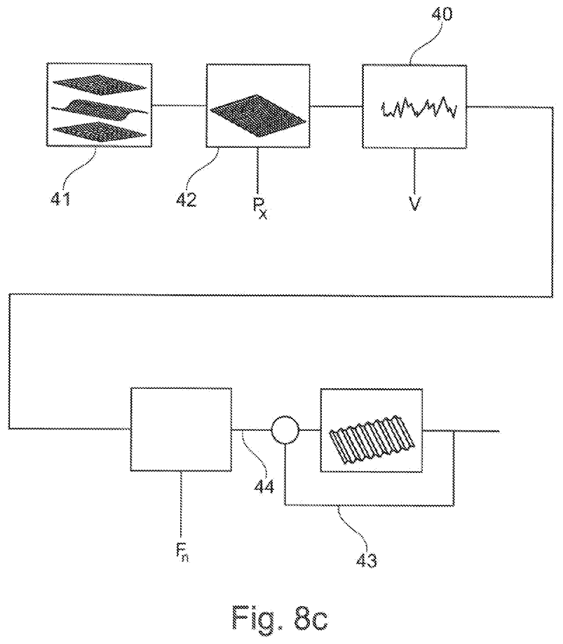

FIG. 8a depicts a 3D device worn by a user;

FIGS. 8b and 8c are block diagrams of a control system according to an implementation example of the invention using a 3D haptic device and a 2D touch system, respectively;

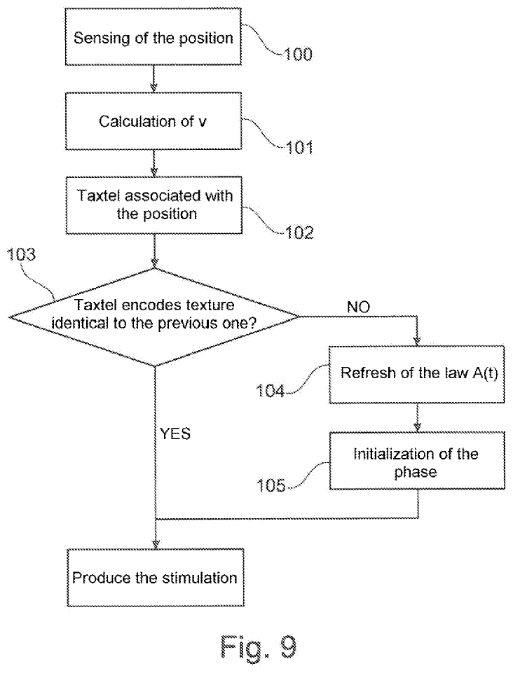

FIG. 9 illustrates an example of a control algorithm for the excitation; and

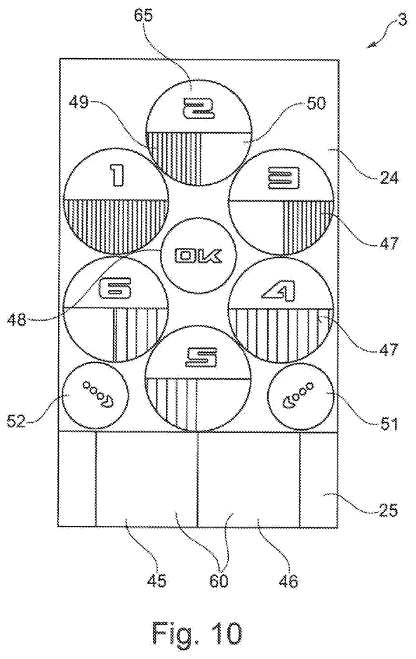

FIG. 10 illustrates an example of an interface for generating tactile patterns and for identifying a user according to the invention.

FIG. 1 depicts an example of a device 1 according to the invention, having a casing 10 having a body 11, closed at the top by a haptic feedback slab 20 having a plate 21 defining a contact surface, which is equipped with an underlying touchscreen 24.

The haptic feedback slab 20 is connected to an electronic circuit 18 arranged inside the casing 10 and visible in FIG. 2, which depicts the device 1 of FIG. 1 without the slab.

The electronic circuit 18 can have, as illustrated, an electronic board 19, for example of “banana PI” type, having an output port communicating with circuits specializing in haptic control of the slab 20, which are referenced 22 and 23. The circuit 22 is for example a specialized microcontroller and the circuit 23 is a power interface controlled by the circuit 22 and having outputs allowing the necessary power to be supplied to piezoelectric transducers 25, which are visible in FIG. 1 and arranged for example in a row on each side of the screen 24. As illustrated, the slab 20 can have two rows of piezoelectric transducers 25 over approximately the whole height of the screen.

The screen 24 is a touchscreen with capacitive detection of the position of the finger. Thus, the electronic circuit 18 can find out the location at which the user presses the touch slab and, on the basis of the location of the finger, can generate the vibrations corresponding to the tactile patterns to be reproduced, by virtue of the transducers 25.

It is possible to use, if need be, one or more of the transducers 25 not as vibration generators but as vibration sensors so as to alter the signal sent to the transducers 25 used as generators in order to refine control of the latter. These sensors allow the amplitude of the vibration to be enslaved to a setpoint, by compensating for the perturbations arising inter alia from the pressure exerted by the finger.

Depicted in isolation and in section in FIG. 3 is a transducer 25 fixed to the plate 21 of the vibrating slab 20, beneath which the touchscreen 24 is arranged.

The transducer 25 has a core 31 made of a piezoelectric material and two electrically conductive layers 27, 29 on the opposite faces of said core, in particular metal layers allowing the supply of electric power to the transducer 25 to be provided and the core 31 made of piezoelectric material to be electrically biased. As a variant, when the transducer 25 is used as a sensor, the conductive layers allow the recovery of a voltage generated by the mechanical stresses applied to the core 31.

In accordance with one aspect of the invention, the lower layer 27 by means of which the transducer 25 is fixed to the plate 21 extends continuously beneath the whole core 31, whereas the upper layer is interrupted at 33 so as to form two electrodes 34 and 35 that are used for supplying electric power to the transducer 25.

The interruption area 33 is situated approximately at the level of a vibration node as can be seen in FIG. 4, which illustrates the deformation of the substrate plate 21 when the transducers 25 are excited.

The transducers 25 create standing waves all along the substrate plate 21, as can be seen in FIG. 5.

Each electrode 34 and 35 preferably has a length, measured in the axis Y of propagation of the vibrations, that is to say parallel to the long sides of the screen in the illustrated example, that is approximately a half-wavelength 2.

FIG. 6 depicts a known arrangement of the transducers on the plate for comparison. According to this arrangement, transducers arranged in pairs are either side of a vibration node are used, the transducers being supplied with electric power in phase opposition, with the disadvantage of having to supply power to each of the transducers at the conductive layer that forms the electrode fixed to the plate.

The plate 21 is made of glass, for example, or, when the screen is removed, may be made of an opaque material.

The screen 24 can be fixed beneath the plate 21 by using adhesive areas, for example. The standing vibrations generated by using the transducers 25 create a deformation in the plate 21, depicted schematically in FIG. 5, with formation of bellies and vibration nodes along the plate 21.

The electronic circuit 18 modulates the amplitude of these vibrations on the basis of the position and/or the speed of movement of the finger of the user over said position, as will be explained later on.

Thus, when a tactile pattern needs to be generated, the vibration amplitude is modulated as a function of time, whereas when a pattern does not need to be generated, the vibration amplitude is constant or zero.

As the vibration nodes of the plate 21 are located at the same place regardless of the vibration amplitude of the plate 21, there is advantageously a benefit in the presence of these nodes in order to provide for the slab 20 to be fixed to the screen 24 by virtue of an adhesive arranged locally beneath the vibration nodes between the plate 21 and the screen 24. This adhesive is for example arranged in the form of thin, narrow strips, the adhesive being a thin double-sided adhesive film, for example.

The excitation frequency of the transducers 25 is dependent on the dimensions of the touch slab 20 and on the wavelength of the generated vibrations. This leads to an excitation frequency of around 60 kHz, for example.

Dark strips 61 have been used in FIG. 7 to depict first areas of the haptic feedback slab 20 that produce a perception, by means of the user moving his finger F in a direction D, of surfaces having a high level of roughness, as opposed to the white strips 62, which are perceived as slippery surfaces by the finger F. In order to produce the rough surface within a dark strip, the amplitude of the vibrations is zero, for example, whereas the amplitude is nonzero within a white strip. All of the first areas alternating with the second areas make up a tactile pattern having the spatial frequency 1/α.

Points P1 have been used in FIG. 7 to schematically show the boundaries of perception, by the user, of the changeover from a first area to a second area or vice versa. For this reason, when the user moves his finger F in the direction D and changes over from a second area to a first area, he perceives a resistance to the movement of his finger on account of the increasing roughness, and vice versa when he changes over from the first area to the second area.

The device 1 is arranged so that when the finger F moves slowly over the slab 20 in the direction D, the vibrations are controlled by position, that is to say that the amplitude of the vibrations of the slab are controlled solely on the basis of the absolute position of the finger. The amplitude is then modulated so that, when the position of the finger is detected as corresponding to arrival at the boundary between a slippery strip and a rough strip, the amplitude of the vibrations increases to produce the sensation of a slippery area, and when the finger is detected as leaving the slippery area, the amplitude of the vibrations is returned to 0. The position of the finger F is detected by virtue of the information provided by the touchscreen 24, for example, but the position of the finger F could be detected in another way, for example by an appropriate optical sensor.

In accordance with one aspect of the invention, the control of vibration of the haptic feedback slab 20 also takes account of the speed of movement of the finger F over said slab. This is because when the density of the tactile pattern becomes higher, that is to say that the strips in FIG. 7 become finer and closer together, it becomes difficult to detect the absolute position of the finger F with good resolution considering the passband and the accuracy of detection of this position. In this case, texture-based control is effected, with modulation of the friction of the finger over the haptic feedback surface on the basis of the speed of the finger so that the user perceives a frequency of change from slippery to rough that is the same as in the case of position-based control. The phase of the haptic signal is then no longer important.

The approach used and described below allows management of the two types of tactile patterns, namely not very dense and dense. This approach is advantageously implemented in order to generate multiple patterns within respective regions of the haptic feedback slab 20.

As a texture is defined according to the invention by a haptic signal characterized by a spatial period less than 8 mm, this has what is known as a “taxtel” associated with it, that is to say a short path element travelled over by the finger where the phase of the haptic signal is not important. The maximum length of a taxtel is less than 8 mm.

A tiled area of taxtels, for example square or rectangular taxtels, the diagonal of which is less than 8 mm, for example squares of size 5×5 mm, is defined for device 1.

The device 1 allows one or more tactile patterns to be generated at predefined locations on the plate 21. The pattern(s) to be generated are for example stored within grids (also called “maps”) of taxtels, which have been schematically illustrated in FIGS. 8b and 8c by a block 41. Each taxtel encodes a texture. The taxtels are connected to one another by a phase notion. In particular, the changeover from one taxtel to another, when they are associated with one and the same texture, ensures the continuity of the phase within the texture. The relative phase from one taxtel to another is thus preserved, but not the absolute phase, connected to the position, of the texture.

The device 1 detects the position Px of the finger, which corresponds to step 100 in FIG. 9, and selects the corresponding taxtel, associated with the position, in step 102. The speed of the finger can be estimated in step 101.

The operation of selection of the taxtel is shown schematically by block 42 in FIGS. 8b and 8c.

The taxtel encodes a texture that is dependent on the speed V of the finger, which has been schematically shown by block 40 in FIGS. 8b and 8c.

Taking the example of a 2D device whose surface is broken down into taxtels, the relationship connecting the amplitude A(t) of the stimulation of the finger pad to be effected on the basis of the speed is given in equation 1, for example:

$$A ( t ) = {B}_{1} ( \frac{1}{2} + \frac{1}{2} sin ( 2 Π \frac{\int vdt}{{PS}_{1}} + {Φ}_{1} ) ) + {C}_{1} \qquad ( 1 )$$

where B₁ and C₁ are constants allowing control of the amplitude of the variations of the stimulation and the average level thereof, t is the time, v is the estimated speed of the finger, Φ₁ is the phase of the texture, and PS₁<8 mm is the spatial period of the texture. It should be noted that ∫vdt does not represent the position of the finger, because the estimated speed v is marred by errors. Whenever the position of the finger is sensed again, the speed is estimated, and it allows determination of the taxtel in which the finger is located.

Two cases need to be considered, as illustrated by block 103 in FIG. 9:
the finger is located on a taxtel associated with the same texture as previously: relationship A(t) remains unchanged, and the phase Φ₁ keeps the same value,
the finger is located on a taxtel associated with a different texture than previously: relationship (1) is refreshed in step 104 to become, by way of example:

$$A ( t ) = {B}_{2} ( \frac{1}{2} + \frac{1}{2} sin ( 2 Π \frac{\int vdt}{{PS}_{2}} + {Φ}_{2} ) ) + {C}_{2} \qquad ( 2 )$$

The phase value Φ₂ is then initialized at that moment (step 105) to a value that is judged suitable. By way of example, the value of Φ₂ can be chosen such that the magnitude A(t) is continuous on changing over from the taxtel; the decision may also be for it to be chosen to be zero. PS₂ is the spatial period associated with the new texture.

This approach allows reproduction of low-density textures, without changing the algorithm as defined by equation 1. This is because for low-density textures, that is to say larger than the dimension of a taxtel, it suffices to define zero values of B₁ and B₂; the stimulation is then constant (defined by C₁ and C₂) per taxtel area. A periodic texture will be able to be reproduced by the alteration of these areas. The control automatically becomes position-based control.

In the case of a 3D haptic device 90, the amplitude A(t) of the stimulation of the finger pad to be effected is transmitted to the haptic device 70, as illustrated in FIG. 8b. This device can be worn by a user, for example on his finger, as illustrated in FIG. 8a, in the manner of a thimble, or else in the form of an articulated arm or a glove fitted with position sensors that communicate the movements of the user to a device 80. The device 70 is connected to the device 80 measuring the position and the speed of the finger and to a virtual reality helmet 75.

In the case of a 2D touch system, as illustrated in FIG. 8c, the device 1 has a feedback loop 43 allowing generation of the standing waves with an amplitude that is controlled by a signal 44 on the basis of the pattern to be reproduced, for the purpose of producing the desired stimulation of the finger pad. The control signal for controlling the amplitude of the vibrations is provided on the basis of inputs that are the position Pₓ of the finger in the direction D and the speed V of the finger in this direction, as explained previously. If need be, the signal is also dependent on the normal contact force Fₙ of the finger, as illustrated in FIG. 8c.

The hybrid control that has just been described can be used in numerous ways. One example of application will now be described with reference to FIG. 10, which has been used to depict an interface 3 that can be used to allow a user to enter a code in a discrete manner.

FIG. 10 illustrates an interface 3 for generating tactile patterns according to the invention. This interface 3 comprises a haptic feedback surface 60 over which a user can move a finger to perceive a tactile pattern, a screen 24 presenting information encoding elements 65, in this case numbers, associated with graphical representations 47 of tactile patterns capable of being generated and selection means 48, 51, 52 allowing a user of the interface to select a graphical representation 47 of what is perceived.

In the example illustrated, the haptic feedback surface 60 is divided into two distinct regions 45 and 46, in each of which a tactile pattern is capable of being generated.

A graphical representation 47 on the screen 24 also has two distinct regions 49, 50, each of these regions expressing the presence or absence of a generated tactile pattern.

The presence of a tactile pattern is represented by a set of lines of greater or lesser width and with greater or lesser spacing from one another.

For a dense pattern, like the one associated with the number “1”, the lines are fine and close to one another, and for a low-density pattern, like the one associated with the number “4”, the lines are broad and spaced apart from one another.

For example, the graphical representation 47 of the pattern associated with the number “3” corresponds to a dense pattern in the right-hand region of the lower semicircle that will be generated in the right-hand region 46 of the haptic feedback surface 60. No pattern will be generated in the left-hand region 45.

In this example, the selection means of the “OK” key 48 allowing confirmation of a choice of the user and the two arrows 51 and 52 allowing the user to move from one number to another.

In another example, the selection means can also be a switch, a key pad, a gesture and/or voice recognition interface, etc.

The method allowing the user to enter information, implementing the interface 3, starts with step a) of generating on the haptic feedback surface 60 at least one tactile pattern to be perceived. This generation is preferably at random.

Depending on the perceived sensations and the graphical representations of the tactile patterns that he sees on the screen 24, the user guesses the number that is involved. This number is the starting number from which he needs to use the arrows 51 and 52 to go to the number corresponding to the first number of his identification code.

Next, he confirms his selection with the “OK” key. Step b) of the method consists in detecting this selection.

The user reiterates the perception and selection until the whole code is input.

The authentication method comprises comparison between the selection made and expected data prerecorded in a database.

The method also comprises generation of authentication information for the user on the basis of the result of the comparison. If the selection made is identical to the expected data, the user is authenticated.

The steps of comparison and generation of authentication information can be performed either after each selection or after full input of the identification code.

For example, if the identification code is “4256” and the first pattern generated on the haptic feedback surface corresponds to the number “3”, the user needs to move one notch with the right-hand arrow 51 to arrive at the number “4”, for which he will be able to perceive the associated tactile patterns. When the user confirms his selection, the interface 3 allows him to continue to input his code. As he is on the number “4”, he will have to press the left-hand arrow 52 twice or the right-hand arrow 51 four times to arrive at the number “2”, which is the next information to be entered, and so on, until full input of the code. If this input is correct, the user is authenticated.

The method according to the invention thus makes it impossible to visually and/or audibly intercept the identification code.

The invention applies to the field of haptics in a general way, and in particular to the identification of a user by means of a code in particular in public places.

Of course, the invention is not limited to the examples that have just been described.

For example, the modulation of friction can be performed by modulating the electrostatic adhesion between the finger and the surface by applying an electric current.

If the selection means is made up of a single key, the interface can generate the tactile patterns to be perceived by the user in a successive manner. The user then presses the selection key only when he feels the tactile pattern for which the graphical representation needs to be selected.

1. A method for generating at least one tactile pattern using a haptic feedback device having an active space within which a user can move his finger order to feel the tactile pattern, a perception of the pattern being caused by the modulation of mechanical excitation of the finger pad of the user by an excitation element, the method having the steps involving:
detecting the position of the finger in the active space;
calculating the speed of the finger,
determining, for each detected position of the finger, an associated taxtel within a predefined grid of taxtels, each taxtel having an associated texture value that is dependent on the tactile pattern to be reproduced, each taxtel having its largest dimension less than or equal to 8 mm,
generating, on the basis of the texture value associated with this taxtel, a control signal for controlling the excitation element, this excitation signal being dependent on the speed of the finger at least for the densest tactile patterns to be reproduced.

2. The method as claimed in claim 1, the modulation of the mechanical excitation of the finger pad being effected by the modulation of the friction of the finger on a haptic feedback surface via the modulation of a vibratory and/or electrical excitation of the surface.

3. The method as claimed in claim 2, the modulation of the friction occurring through electrical adhesion or through ultrasonic vibration.

4. The method as claimed in claim 2, the haptic feedback surface at least partially overlapping a screen.

5. The method as claimed in claim 4, the screen presenting a graphical representation of a generated tactile pattern.

6. The method as claimed in claim 4, the screen displaying information in connection with the generated tactile patterns.

7. The method as claimed in claim 2, the haptic feedback surface having a plurality of distinct regions in each of which a tactile pattern is capable of being generated.

8. The method as claimed in claim 1, in which it is determined whether a taxtel corresponding to a recently detected position of the finger encodes a texture identical to that of the taxtel associated with the previously detected position of the finger, and if not a refresh of the control signal is performed.

9. The method as claimed in claim 1, the control signal being such that the amplitude of the stimulation A(t) of the finger pad is in the form:
$$A ( t ) = {B}_{1} ( \frac{1}{2} + \frac{1}{2} sin ( 2 Π \frac{\int vdt}{{PS}_{1}} + {Φ}_{1} ) ) + {C}_{1} \qquad ( 1 )$$
where B₁ and C₁ are constants allowing control of the amplitude of the variations of the stimulation and the average level thereof, t is the time, v is the estimated speed of the finger, Φ₁ is the phase of the texture, and PS₁<8 mm is the spatial period of the texture.

10. The method as claimed in claim 9, in which during said refresh of the control signal, relationship (1) is refreshed to become:
$$A ( t ) = {B}_{2} ( \frac{1}{2} + \frac{1}{2} sin ( 2 Π \frac{\int vdt}{{PS}_{2}} + {Φ}_{2} ) ) + {C}_{2} \qquad ( 2 )$$
where B₂ and C₂ are constants allowing control of the amplitude of the variations of the stimulation and the average level thereof
and in which the phase value Φ₂ is initialized to a value such that the magnitude A(t) is continuous on changing over from the previous taxtel to the new, or is chosen to be zero.

11. A device for generating at least one tactile pattern having:
a haptic feedback device having a 3D or 2D active space within which a user can move his finger in order to feel the tactile pattern, the perception of the pattern being caused by the modulation of the mechanical excitation of the finger pad, and means for:
detecting the position of the finger in the active space;
calculating the speed of the finger,
determining, for each detected position of the finger, an associated taxtel within a predefined grid of taxtels, each taxtel having an associated texture value that is dependent on the tactile pattern to be reproduced, each taxtel having a largest dimension less than or equal to 8 mm,
generating, on the basis of the texture value associated with this taxtel, a control signal for controlling the excitation element, this excitation signal being dependent on the speed of the finger at least for the densest tactile patterns to be reproduced.

12. The device as claimed in claim 11, in which the haptic feedback device is a device able to be worn by the user having a 3D active space, the perception of the pattern being caused by the modulation of the mechanical excitation of the finger pad by an excitation element.

13. The device as claimed in claim 11, in the form of an interface, comprising:
a haptic feedback device having a 2D active space in the form of a haptic feedback surface over which a user can move his finger in order to feel at least one tactile pattern, perception of the pattern being caused by the modulation of the mechanical excitation of the finger pad on the haptic feedback surface via the modulation of a vibratory and/or electrical excitation of the surface;
a touchscreen presenting at least one graphical representation of a tactile pattern capable of being generated,
at least one selection means allowing a user of the interface to select a graphical representation of what is perceived.

14. The device as claimed in claim 13, the modulation of the mechanical excitation of the finger pad being effected through the modulation of the friction of the finger on the haptic feedback surface.

15. The device as claimed in claim 13, the touchscreen presenting multiple graphical representations of tactile patterns capable of being generated.

16. The device as claimed in claim 13, the haptic feedback surface and the touchscreen being separate.

17. The device as claimed in claim 13. said at least one selection means being displayed on the screen.

18. The device as claimed in claim 13, the haptic feedback surface having a plurality of distinct regions in each of which a tactile pattern is capable of being generated.

19. The device as claimed in claim 13, a graphical representation having as many distinct regions as the haptic feedback surface, each of these regions expressing the presence or absence of a generated tactile pattern.

20. The device as claimed in claim 13, the presence of a tactile pattern being represented by a set of lines of greater or lesser width and with greater or lesser spacing from one another.

21. The device as claimed in claim 13, the lines being arranged transversely, or rather perpendicularly, to the direction of movement of the finger.

22. The device as claimed in claim 13, said at least one selection means being a confirmation key and/or at least one navigation key.

23. The device as claimed in claim 13, being configured to display multiple information encoding elements on the screen.

24. The device as claimed in claim 13, being configured to randomly generate at least one tactile pattern corresponding to one of the information encoding elements on the haptic feedback surface.

25. The device as claimed in claim 23, being configured to allow the user to navigate among the information encoding elements up to the one that he needs to select.

26. The device as claimed claim 23, being configured to allow the user, following recognition of the perceived tactile pattern, to use said at least one selection means to select the corresponding information encoding element.

27. The device as claimed in claim 13, the haptic feedback surface or at least one of the distinct regions thereof being a vibrating haptic feedback slab having:
a plate defining a contact surface; and
at least one piezoelectric transducer having a piezoelectric material arranged between two conductive electrical layers, one of which is fixed to the substrate plate,
the layer opposite the one fixed to the substrate plate being interrupted in order to form two power supply electrodes of the transducer.

28. The device as claimed in claim 27, the interrupted layer of the vibrating slab being interrupted in an area corresponding to a vibration node.

29. The device as claimed in claim 27, the length of a power supply electrode of the vibrating slab being close to a half-wavelength of the generated vibration.

30. The device as claimed in claim 27, the plate of the slab being made of a material selected from among:
glass or another transparent material; and
an opaque material.

31. A method allowing a user to enter information, by implementing the device in the form of an interface as claimed in claim 13, comprising:
a) generation, on the haptic feedback surface, of at least one tactile pattern to be perceived by a user of the interface using the method as claimed in claim 1; and
b) detection of a selection, by the user, of a graphical representation displayed on the screen of the interface.

32. The method as claimed in claim 31, comprising comparison between the selection made and expected data.

33. The method as claimed in claim 32, comprising generation of authentication information for the user on the basis of the result of the comparison.

34. The method as claimed in claim 31 and implementing the device in the form of an interface, the user pressing said at least one navigation key in order to change over from the perception of one tactile pattern to another.

35. The method as claimed in claim 31 and implementing the device in the form of an interface, the user confirming the selection by pressing the confirmation key.
